(19) United States
(12) Patent Application Publication
(10) Pub. No.: US 2025/0274888 A1
(43) Pub. Date: Aug. 28, 2025

(54) COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: Masatomo Ouchi, Tokyo (JP)

(21) Appl. No.: 19/205,012

(22) Filed: May 12, 2025

Related U.S. Application Data
(63) Continuation of application No. PCT/JP2023/037362, filed on Oct. 16, 2023.

(30) Foreign Application Priority Data
Nov. 22, 2022 (JP) 2022-186606

(51) Int. Cl. H04W 56/00; H04W 76/15; H04W 84/12

(52) U.S. Cl. CPC H04W 56/0015; H04W 76/15; H04W 84/12

(57) ABSTRACT

A communication apparatus for performing wireless communication complying with an IEEE 802.11 standard that performs communication by establishing a first wireless link and a second wireless link with another communication apparatus controls, in a case where transmission of a second frame in the second wireless link ends while transmitting a first frame in the first wireless link in a state in which the communication unit transmits frames so that a first timing at which a frame transmitted in the first wireless link ends is synchronized with a second timing at which a frame transmitted in the second wireless link ends, the communication unit to transmit, to the other communication apparatus in the first wireless link, a predetermined frame that requests assistance for recovery of the synchronization from the other communication apparatus and includes information capable of designating a timing of recovering the synchronization.

### CROSS-REFERENCE TO RELATED APPLICATIONS

This application is a Continuation of International Patent Application No. PCT/JP2023/037362, filed Oct. 16, 2023, which claims the benefit of Japanese Patent Application No. 2022-186606, filed Nov. 22, 2022, both of which are hereby incorporated by reference herein in their entirety.

### BACKGROUND

### Field of the Technology

The present disclosure relates to a wireless communication technique using a plurality of wireless links.

### Description of the Related Art

As a communication standard concerning a wireless Local Area Network (LAN), the IEEE 802.11 standard series is known. The IEEE 802.11ax standard as the latest standard implements improvement of a communication speed under a congested situation using Orthogonal Frequency-Division Multiple Access (OFDMA), in addition to high peak throughput. Presently, to further improve the throughput, a successor standard of the IEEE 802.11ax standard has been studied. To formulate the standard, the 802.11be TG (Task Group) is active, following an SG (Study Group) called IEEE 802.11 EHT (Extreme or Extremely High Throughput).

One of measures for throughput improvement that is a target for the TG is Multi-Link communication in which an Access Point (AP) or non-AP performs application communication using a plurality of wireless interfaces. PTL 1 describes that communication is performed synchronously in a plurality of links using Multi-Link communication.

### CITATION LIST

### Patent Literature

PTL 1: US-2021-0211375

Multi-Link communication can be implemented in one of a form in which transmission and reception of signals can be executed in parallel and a form in which transmission and reception of signals cannot be executed in parallel. If, while transmission is performed in a plurality of links, transmission in one link ends early, a communication apparatus that cannot execute transmission and reception in a plurality of links in parallel cannot perform reception processing in the link, and thus cannot ascertain the state of the link. Therefore, if communication in one link ends early, such communication apparatus waits for the elapse of a predetermined time, and there is room for improvement in efficiency of communication.

### SUMMARY

The present disclosure provides a technique of improving efficiency of Multi-Link communication.

A communication apparatus according to one aspect of the present disclosure is a communication apparatus for performing wireless communication complying with an IEEE 802.11 standard, comprising: a communication unit configured to perform communication by establishing a first wireless link and a second wireless link with another communication apparatus; and a control unit configured to control, in a case where transmission of a second frame in the second wireless link ends while transmitting a first frame in the first wireless link in a state in which the communication unit transmits frames so that a first timing at which a frame transmitted in the first wireless link ends is synchronized with a second timing at which a frame transmitted in the second wireless link ends, the communication unit to transmit, to the other communication apparatus in the first wireless link, a predetermined frame that requests assistance for recovery of the synchronization from the other communication apparatus and includes information capable of designating a timing of recovering the synchronization.

A communication apparatus according to another aspect of the present disclosure is a communication apparatus for performing wireless communication complying with an IEEE 802.11 standard, comprising: a communication unit configured to perform communication by establishing a first wireless link and a second wireless link with another communication apparatus; and a control unit configured to control, in a case where a first predetermined frame that requests assistance for recovery from a synchronization loss between the first wireless link and the second wireless link in the other communication apparatus and includes information capable of designating a timing of recovering synchronization is received in the first wireless link from the other communication apparatus, the communication unit to transmit a second predetermined frame in the second wireless link at a timing based on the information capable of designating the timing.

Features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a view showing a system configuration.

FIG. 2 is a block diagram showing an example of the hardware configuration of a communication apparatus.

FIG. 3 is a block diagram showing an example of the functional configuration of the communication apparatus.

FIG. 4 is a view for explaining a MAC frame format.

FIG. 5A is a view for explaining an HT Control field format.

FIG. 5B is a view for explaining an AAR (AP Assistance Request).

FIG. 6A is a view for explaining a Multi-Link element and Medium Synchronization Delay Information.

FIG. 6B is a view for explaining the Multi-Link element and Medium Synchronization Delay Information.

FIG. 7A is a view for explaining a trigger frame.

FIG. 7B is a view for explaining the trigger frame.

FIG. 7C is a view for explaining the trigger frame.

FIG. 7D is a view for explaining the trigger frame.

FIG. 8 is a sequence chart showing an example of the procedure of communication in a system.

FIG. 9 is a sequence chart showing an example of the procedure of communication in the system.

FIG. 10 is a flowchart illustrating an example of the procedure of processing executed by an STA.

FIG. 11 is a flowchart illustrating an example of the procedure of processing executed by an AP.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosed technique that requires all such features, and multiple such features may be combined as appropriate. Furthermore, in the attached drawings, the same reference numerals are given to the same or similar configurations, and redundant description thereof is omitted.

### System Configuration

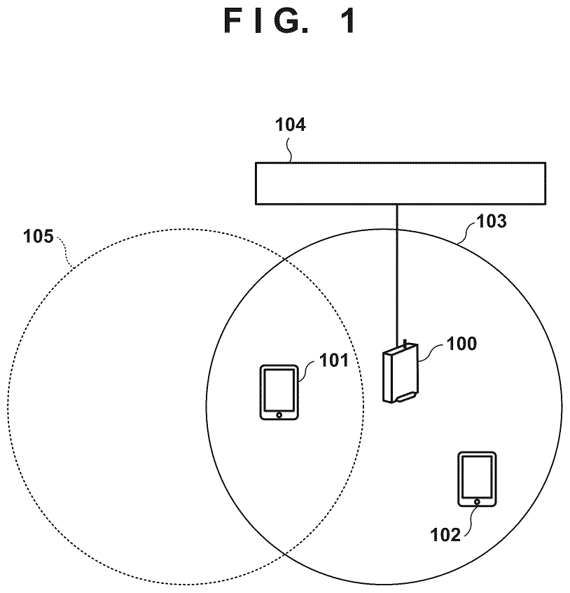

An example of the configuration of a wireless communication system according to this embodiment will be described with reference to FIG. 1. The wireless communication system is a wireless communication system using a wireless Local Area Network (LAN), in which an Access Point (AP) configures and manages a network (BSS). Note that BSS stands for Basic Service Set. The AP performs, for example, wireless LAN communication complying with the IEEE 802.11 standard series with a currently connected station (STA) (that joins the BSS managed by the self-apparatus). Note that IEEE is an abbreviation for Institute of Electrical and Electronics Engineers. The AP is the base station of a wireless LAN, and the STA is the terminal of the wireless LAN. Referring to FIG. 1, an AP 100 manages a BSS 103, and performs communication between STAs 101 and 102 that join the BSS 103. Note that the AP 100 and the STAs 101 and 102 have a Multi-Link communication function of using a plurality of wireless links simultaneously. Note that the Multi-Link communication function is a function of making it possible to perform high-speed or high-quality communication, as compared to a case where one wireless link operates individually, by synchronizing a plurality of wireless interfaces with each other or making them cooperate with each other. High-quality communication indicates communication that satisfies a predetermined requirement such as a high signal-to-noise ratio (SNR), low interference (for example, a high SINR), low delay, or low jitter.

A DS 104 is a Distribution System. The AP 101 is connected to another BSS or an external network via the DS 104. For example, the AP 101 can perform communication, via the DS 104, with another AP that provides a BSS 105 different from the BSS 103 managed by the self-apparatus. Note that FIG. 1 shows a state in which the STA 101 belongs to an area where the area of the BSS 103 and the area of the BSS 105 overlap each other, and may thus interfere with a signal transmitted by an AP or an STA of the BSS 105. The AP 101 establishes wired connection or wireless connection to the DS 104, and communicates with it. The AP 101 can use, for example, a telephone line, a communication line using Ethernet®, or the like for wired connection. Alternatively, the AP 101 can use, for example, a communication line using Long Term Evolution (LTE), Worldwide Interoperability for Microwave Access (WiMAX), or the like for wireless connection. The AP 101 may be connected to the DS 104 using a wireless LAN complying with the IEEE 802.11 standard. In this case, when performing connection to the DS 104, the AP 101 may use the same wireless channel as that used for communication with a peripheral STA or a different wireless channel.

Note that FIG. 1 shows only one AP (AP 100). However, for example, two or more APs such as another AP that manages the BSS 105 may exist, as a matter of course. In addition, FIG. 1 shows two STAs (STAs 101 and 102) but more STAs may exist or the number of STAs may be one. FIG. 1 only shows that the AP and the STA operate as the base station and the terminal of a wireless LAN, respectively, and they can be, for example, arbitrary communication apparatuses each capable of operating as both an AP and an STA.

The communication apparatus having the Multi-Link communication function is classified in accordance with whether it can execute reception processing in another wireless link while performing transmission in one wireless link. The communication apparatus that can execute reception processing in another wireless link while performing transmission in one wireless link is called an STR (Simultaneous Transmit and Receive) terminal. On the other hand, the communication apparatus that cannot execute such reception processing is called an NSTR (Non-STR) terminal. Since a wireless signal transmitted in a first wireless link interferes with a reception signal in a second wireless link, the NSTR terminal cannot correctly demodulate a signal from another communication apparatus in the second wireless link. Therefore, when the NSTR terminal performs Multi-Link communication, it is general to synchronize the transmission timing and the reception timing in the wireless links. To synchronize the timings, there is a need to, for example, end signal transmission operations in the plurality of wireless links at the same time, prevent reception while a signal is transmitted in any one of the wireless links, and cause a transmission partner to end transmission operations in the plurality of wireless links at the same time. To perform synchronous communication by satisfying the requirement, the NSTR terminal executes a synchronization control procedure with another communication apparatus as a communication partner. For example, if the STA 101 or 102 is the NSTR terminal, the STA executes, with the AP 101, the synchronization control procedure so that signal transmission operations or signal reception operations in two or more wireless links end at the same time.

It is assumed that synchronization in the plurality of wireless links is lost during communication and the end timing of signal transmission (or reception) in one wireless link does not match the end timing of signal transmission (or reception) in another wireless link. In this case, the communication apparatus needs to execute a procedure for reestablishing synchronization. When it is detected that synchronization is lost, the STA can execute a synchronization recovery procedure after standing by for a predetermined time. However, in this procedure, synchronization cannot be recovered during the standby time. To the contrary, there exists an AP Assistance Request (AAR) as a procedure of requesting the AP to transmit a trigger frame (TF) and performing synchronization recovery based on the TF. In the AAR, the STA can recover synchronization early by requesting the AP to transmit a TF. However, conventionally, after receiving the request of the TF, the AP transmits no TF in a case where the AP exchanges a frame with another STA, and the STA can thus execute the synchronization recovery procedure after standing by for a predetermined standby time. Depending on a communication service executed by the STA, an allowable time until synchronization is recovered may be limited. In this case, it can be assumed that whether the AP transmits the TF within the allowable time is uncertain, and thus the STA cannot maintain the high-quality communication service.

Therefore, in this embodiment, when the STA requests the AP to transmit a TF by the AAR, a time within which the TF is to be transmitted can be designated. By designating the time, the AP can transmit the TF at an appropriate timing, and it is possible to maintain high-quality communication service in the STA. In addition, since Multi-Link communication can sufficiently be used, it is possible to improve efficiency of communication. The configuration of the AP and the STA that execute the above-described communication processing and an example of the procedure of processing executed by each of the apparatuses will be described in detail below. Note that the following embodiment will describe a case where two wireless links are used, for the sake of descriptive simplicity, but the present disclosure is not limited to this. That is, the following discussion can also be applied to a case where three or more wireless links are used.

### Apparatus Configuration

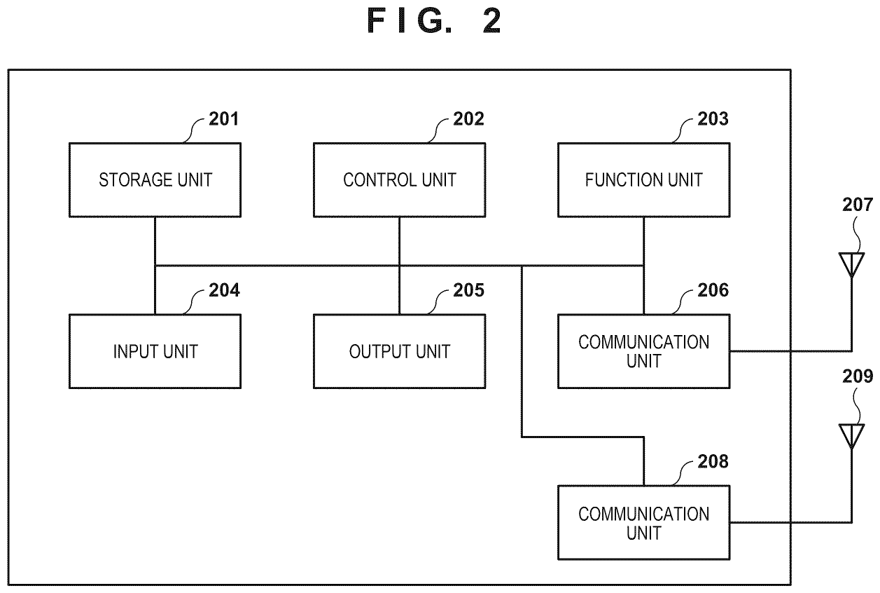

FIG. 2 shows an example of the hardware configuration of the communication apparatus operating as the AP or the STA according to this embodiment. The communication apparatus includes, for example, a storage unit 201, a control unit 202, a function unit 203, an input unit 204, an output unit 205, a first communication unit 206 and its corresponding antenna 207, and a second communication unit 208 and its corresponding antenna 209.

The storage unit 201 is configured to include a memory such as a Read Only Memory (ROM) and a Random Access Memory (RAM), and stores programs for performing various kinds of operations to be described later, and various kinds of information such as communication parameters for wireless communication. Note that other than the memory such as the ROM and the RAM, the storage unit 201 may include a storage medium such as a flexible disk, a hard disk, an optical disk, a magneto-optical disk, a CD-ROM, a CD-R, a magnetic tape, a nonvolatile memory card, or a DVD. The storage unit 201 may include a plurality of memories.

The control unit 202 is formed by, for example, a processor such as a CPU or an MPU, an Application Specific Integrated Circuit (ASIC), a Digital Signal Processor (DSP), a Field Programmable Gate Array (FPGA), or the like. Note that CPU is an acronym for Central Processing Unit, and MPU is an acronym for Micro Processing Unit. For example, the control unit 202 controls the whole communication apparatus by executing the programs stored in the storage unit 201. Note that the control unit 202 may control the communication apparatus by cooperation of the programs stored in the storage unit 201 and an OS (Operating System). The control unit 202 may include a plurality of processors such as a multi-core processor.

The control unit 202 can control the function unit 203 to implement a predetermined function such as an AP function of causing the communication apparatus to function as the AP, an STA function of causing the communication apparatus to function as the STA, an image capturing function, a print function, or a projection function. The function unit 203 is configured to include hardware used by the communication apparatus to execute the predetermined processing.

The input unit 204 accepts various kinds of operations from the user. The output unit 205 performs various kinds of outputs to the user. In this example, the output by the output unit 205 includes at least one of display on a screen, audio output by a loudspeaker, a vibration output, and the like. Note that both the input unit 204 and the output unit 205 may be implemented by one module, like a touch panel.

Each of the first communication unit 206 and the second communication unit 208 executes control of wireless communication complying with the IEEE 802.11 standard series, control of wireless communication complying with Wi-Fi®, control of IP (Internet Protocol) communication, and the like. The first communication unit 206 and the second communication unit 208 respectively control the corresponding antennas 207 and 209 to transmit/receive wireless signals for wireless communication. FIG. 2 assumes a case where the one antenna 207 and the one antenna 209 are arranged but a plurality of antennas 207 and a plurality of antennas 209 may be provided. In general, antennas the number of which corresponds to the number of streams to be processed in each communication unit are prepared. Each communication unit and its corresponding antenna can be configured to support communication in the 6-GHz band operationally introduced from the IEEE 802.11ax standard in addition to communications in the 2.4- and 5-GHz bands. However, this is merely an example, and each communication unit and its corresponding antenna may be configured to be able to perform communication in another frequency band. This embodiment assumes that the first communication unit 206 and the second communication unit 208 of the communication apparatus operating as the AP or the STA are configured to execute communication of a wireless frame complying with the IEEE 802.11be standard. However, the present disclosure is not limited to this. For example, the first communication unit 206 and the second communication unit 208 can be configured to execute communication of a wireless frame complying with a successor standard of the IEEE 802.11be standard, which aims at 90 Gbps to 100 Gbps or more as a maximum transmission rate. The main features of the successor standard of the IEEE 802.11be standard are support for highly reliable communication and low-latency communication, and AP cooperation. In this embodiment, in consideration of this, the successor standard of the IEEE 802.11be standard, which aims at 90 Gbps to 100 Gbps or more as a maximum transmission rate is also called IEEE 802.11UHR (Ultra High Reliability). A communicated wireless frame complying with the successor standard is also called a UHR PPDU hereinafter. PPDU is an abbreviation for PLCP Protocol Data Unit, and PLCP is an abbreviation for Physical Layer Convergence Protocol. Note that the name “EEE802.11UHR” or “UHR standard” is provided for convenience in consideration of the target to be achieved by the successor standard and the feature focused on in the standard, and can be a different name upon completion of the formulation of the standard. On the other hand, the scope of this specification and the appended claims can substantially be applied to a communication apparatus that supports Multi-Link communication complying with the IEEE 802.11be standard and Multi-Link communication complying with the successor standard. Note that the wireless frame complying with the IEEE 802.11be standard is also called an EHT PPDU.

The control unit 202 and the function unit 203 perform an operation for Multi-Link communication by combining the two sets of the communication units and the antennas (the first communication unit 206 and the antenna 207, and the second communication unit 208 and the antenna 209).

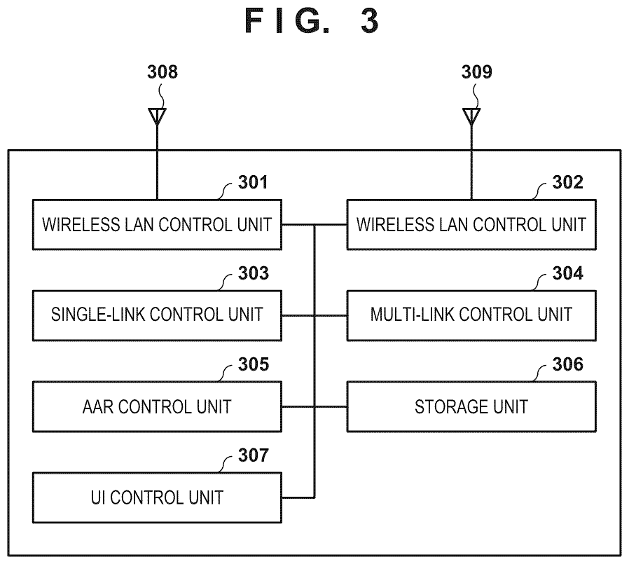

FIG. 3 shows an example of the functional configuration of the communication apparatus. For example, the communication apparatus includes, as its functions, a first wireless LAN control unit 301, a second wireless LAN control unit 302, and antennas 308 and 309 respectively corresponding to them. The communication apparatus further includes a Single-Link control unit 303, a Multi-Link control unit 304, an AAR control unit 305, a storage unit 306, and a UI control unit 307. Note that these functions may be implemented by the communication apparatus when, for example, the control unit 202 executes the programs stored in the storage unit 201. This is merely an example, and some or all of the functions may be implemented by dedicated hardware components, or may be implemented as, for example, the internal functions of the first communication unit 206 and the second communication unit 208. Note that the first wireless LAN control unit 301 and the second wireless LAN control unit 302 will be referred to as “wireless LAN control units” hereinafter if it is unnecessary to particularly discriminate them.

The wireless LAN control unit executes control to transmit/receive a wireless signal to/from another communication apparatus (for example, another AP or STA) in a wireless LAN. The wireless LAN control unit executes wireless LAN communication control such as generation of a wireless frame and transmission of the wireless frame to another communication apparatus in the wireless LAN, and reception of a wireless frame from another communication apparatus in accordance with the IEEE 802.11 standard series. Note that the first wireless LAN control unit 301 and the second wireless LAN control unit 302 basically have the same function but are different according to the frequency channels or frequency bands in which they operate. The antennas 308 and 309 are antennas respectively corresponding to the first wireless LAN control unit 301 and the second wireless LAN control unit 302. Each of the antennas 308 and 309 is configured to, for example, transmit/receive a radio wave in a frequency band used for wireless communication executed by a corresponding one of the first wireless LAN control unit 301 and the second wireless LAN control unit 302. For example, each of the antennas 308 and 309 can be an antenna corresponding to one of the 2.4-, 5-, and 6-GHz bands. Note that FIG. 3 shows the one antenna 308 and the one antenna 309 but two or more antennas 308 and two or more antennas 309 may be included to correspond to at least two of the 2.4-, 5-, and 6-GHz bands. The 2.4-, 5-, and 6-GHz bands are merely examples, and an antenna corresponding to a frequency band other than these may be used. The Single-Link control unit 303 executes control so that the first wireless LAN control unit 301 and the second wireless LAN control unit 302 operate independently of each other to communicate with another communication apparatus. The Multi-Link control unit 304 executes control to cause the first wireless LAN control unit 301 and the second wireless LAN control unit 302 to perform a synchronization operation or a cooperative operation. The AAR control unit 305 executes control associated with the AP Assistance Request (AAR).

The storage unit 306 executes control to store programs executed by the communication apparatus and various kinds of data in a storage device such as a ROM (Read Only Memory) or a RAM (Random Access Memory). The UI control unit 307 controls the operation of hardware concerning a user interface (UI) such as a touch panel or buttons configured to accept an operation on the AP by a user (not shown) of the communication apparatus. Note that the UI control unit 307 also has a function of presenting information to the user, such as display of an image or the like or audio output.

### Frame Structure

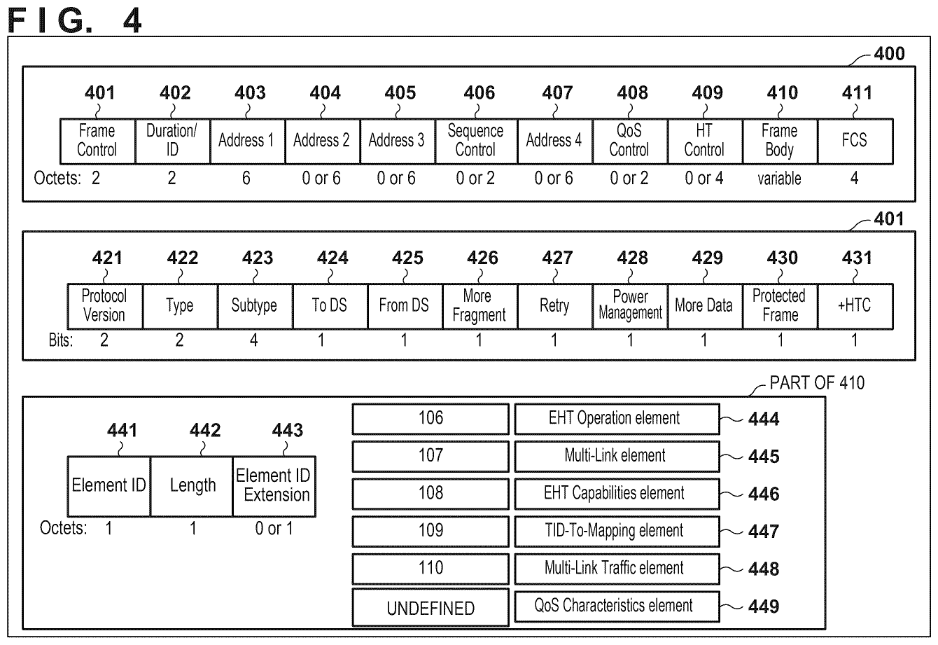

Subsequently, the structure of a frame related to this embodiment will be described with reference to FIGS. 4 to 9.

FIG. 4 shows the structure of a Media Access Control (MAC) frame complying with the IEEE 802.11 standard and an IE (Information Element) as one element of a Frame Body field. A Frame Control field 401 is a field including information concerning control of the overall MAC frame and having a length of 2 octets (16 bits). The Frame Control field 401 includes a plurality of subfields of a Protocol Version subfield 421 to a +HTC subfield 431 to be described later. A Duration field 402 is a field having a length of 2 octets. When indicating a frame length or a time such as a TXOP period, a value in which an MSB (Most Significant Bits: B15) is “1” and the remaining 15 bits represent 0 to 32,767 μs is set in the Duration field 402. In each of a plurality of Address fields (Address fields 403 to 405 and 407), an address such as a BSSID, a transmission source, or a destination is set in accordance with the type (Type subfield 422) or subtype (Subtype subfield 423) of the MAC frame. Note that the Address field used is different depending on the type. A Sequence Control field 406 is a field concerning a sequence number, and includes a 12-bit Sequence Number and a 4-bit Fragment Number. Note that no Sequence Control field 406 is set in the frame without the Frame Body field.

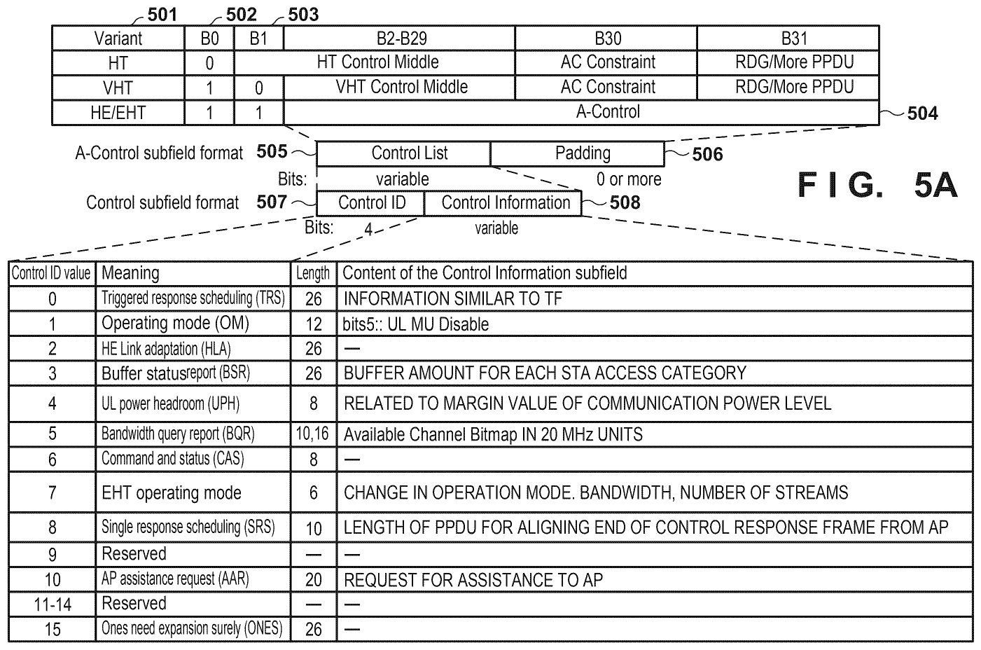

A QOS Control field 408 is a field concerning QoS, and includes two pieces of information. The first information is a 4-bit TID (Traffic Identifier). In the case of the EDCA access method, when the TID is set to a value of 0 to 7, one of four access categories of AC_VO (voice)/AC_VI (video)/AC_BE (best effort)/AC_BK (background) is indicated. The second information is an 8-bit Queue size. The second information is in units of 256 octets, and indicates a data amount remaining in a transmission buffer. By combining the TID and the Queue Size, a notification of the amount of data of the access category designated by the TID, which remains in the buffer, can be sent. An HT Control field 409 will be described later with reference to FIG. 5A.

Various kinds of data to be transmitted are stored in a Frame Body field 410. In a case where the type (Type subfield 422) indicates a management frame, that is, a frame such as a Beacon or a Probe Request/Response, various IEs are set in the Frame Body field 410. An FCS field 411 is a Frame Check Sequence for determining whether an error has occurred in data.

The Protocol Version subfield 421 in the Frame Control field 401 is a 2-bit subfield indicating the protocol version, and is set to 0 for an IEEE 802.11 frame. The Type subfield 422 is a 2-bit subfield, and indicates any of the Management, Control, and Data frames. The Subtype subfield 423 is a 4-bit subfield in which a value for more finely classifying the Management, Control, or Data frame type is stored. The To DS subfield 424 is a 1-bit subfield, and indicates whether the destination of the frame is a DS (Distribution System). The From DS subfield 425 is a 1-bit subfield indicating whether the transmission source of the frame is the DS. The More Fragment subfield 426 is a 1-bit subfield indicating whether the frame is the last fragment of the series of data. The Retry subfield 427 is a 1-bit subfield indicating whether the frame is a retransmitted frame. The Power Management subfield 428 is a 1-bit subfield indicating whether the apparatus is in a power-saving state. The More Data subfield 429 is a 1-bit subfield indicating that there exists data to be transmitted. The Protected Frame subfield 430 is a 1-bit subfield indicating whether the contents of the frame are encrypted. The +HTC subfield 431 is a 1-bit subfield indicating whether, for example, sequence control is performed. The frame in which the +HTC subfield 431 can be set, that is, the frame that can include the HT Control field is each of QoS Data, Management, and RTS frames. Note that the condition whether the +HTC subfield 431 can be set includes more detailed conditions, but a description thereof will be omitted. A frame used to indicate an operation to be described below in this embodiment is a frame in which the +HTC subfield is set.

The structure of an IE included in part of the Frame Body field 410, especially, the frame structure concerning EHT will be described next. An Element ID subfield 441 stores identification information of the information element. With respect to the EHT of the IEEE 802.11be standard, “255” is stored in the Element ID subfield 441 by following a value in the case of the IEEE 802.11ax standard. A Length subfield 442 indicates the length of the information element. In an Element ID Extension subfield 443, information for extending the identification information of the information element is stored. From Draft 1.31 of the IEEE 802.11be standard, six types of information elements in total including five types of information elements indicated by “106” to “110” in the Element ID Extension subfield 443 and “undefined” are added. If the six types of information elements are transmitted, 255 is commonly set in the Element ID subfield 441, and the length corresponding to the contents is set in the Length subfield 442. If the Element ID Extension subfield 443 is “106”, an information element 444 is an EHT Operation element. If the Element ID Extension subfield 443 is “107”, an information element 445 is a Multi-Link element. This information element includes a Basic Multi-Link element and a Probe Request Multi-Link element. If the Element ID Extension subfield 443 is “108”, an information element 446 is an EHT Capabilities element. Similar to the structure complying with the IEEE 802.11ax standard, this information element includes MAC, PHY, Supported EHT-MCS And NSS Set, and PPE Thresholds fields. If the Element ID Extension subfield 443 is “109”, an information element 447 is a TID-To-Link Mapping element. If the Element ID Extension subfield 443 is “110”, an information element 448 is a Multi-Link Traffic element. If the Element ID Extension subfield 443 is “undefined”, an information element 449 is a QoS Characteristics element.

The structure of the HT Control field 409 will be described with reference to FIG. 5A. The HT Control field 409 has a length of 32 bits. A Variant 501 indicates an abbreviation of the IEEE standard. Two bits 502 and 503 are used to specify a standard corresponding to this field. If the bits 502 and 503 are “00”, this indicates that the field is for HT (High Throughput: 802.11n). If the bits 502 and 503 are “10”, this indicates that the field is for VHT (Very High Throughput: 802.11ac). If the bits 502 and 503 are “11”, this indicates that the field is for HE (High Efficiency: 802.11ax) or EHT (Extremely High Throughput: 802.11be). An A-Control field 504 indicates the remaining 30-bit name for HE and EHT. The A-Control field 504 includes a Control List subfield 505 and a Padding subfield 506. The Control List subfield 505 includes a Control ID subfield 507 representing the type of the subfield, and a Control Information subfield 508 representing contents of the subfield.

In this embodiment, as schematically described above, since the AAR is used, the structure of the Control ID subfield 507 and the Control Information subfield 508 for the AAR will be described with reference to FIG. 5B. For the AAR, “10” is set in the Control ID subfield 507. The Control Information subfield 508 includes three fields of an Assisted AP Link ID Bitmap field 521, a time designation field 522, and an offset field 523. The time designation field 522 and the offset field 523 are pieces of information that can designate the time when synchronization is recovered.

The Assisted AP Link ID Bitmap field 521 indicates a 16-bit bitmap. The STA sets a predetermined value (for example, “1”) in a bit corresponding to a link that requests assistance in the bitmap. For example, the first bit of the bitmap corresponds to a link ID=0, and the final bit corresponds to a link ID=15. In this case, by setting the second bit from the first one to “1”, the STA can request the AP to transmit a trigger frame (TF) from the interface of the link ID=1. The time designation field 522 is a 1-bit field indicating whether the subsequent offset field 523 is significant. By setting this bit to “1”, the STA can indicate a transmission timing when the AP should transmit the TF. If “0” is set in the time designation field 522, this indicates that the time is not designated by the STA. In this case, the AP can transmit the TF at an arbitrary timing without considering the status of the STA.

The offset field 523 is a field having a length of 9 bits or less. If “0” is set in a 9-bit region of the offset field 523, this indicates “urgent”. That is, when the STA requests the AP to immediately transmit the TF, it sets “0” in the offset field 523. In this case, “immediately” means that IFS (Inter Frame Space) as a frame interval in the IEEE 802.11 is set to SIFS (Short IFS) or PIFS (Priority IFS). On the other hand, if a value other than “0” is set in the 9-bit region of the offset field 523, this indicates a time other than “urgent”. The STA indicates, by the value stored in the 9-bit region, a time from the end of transmission of the AAR to a timing when the TF is transmitted. As the unit of time, a predetermined value determined between the AP and the STA is used. For example, a unit time such as 1 μs or 32 μs can be used. Note that when the STA sets, in the offset field, a value smaller than the value of a MediumSyncDelay timer to be described later, it can attempt synchronization recovery processing at a timing earlier than a timing defined by MediumSyncDelay Information. Note that “MediumSyncDelay” will sometimes be referred to as “Medium Synchronization Delay” hereinafter.

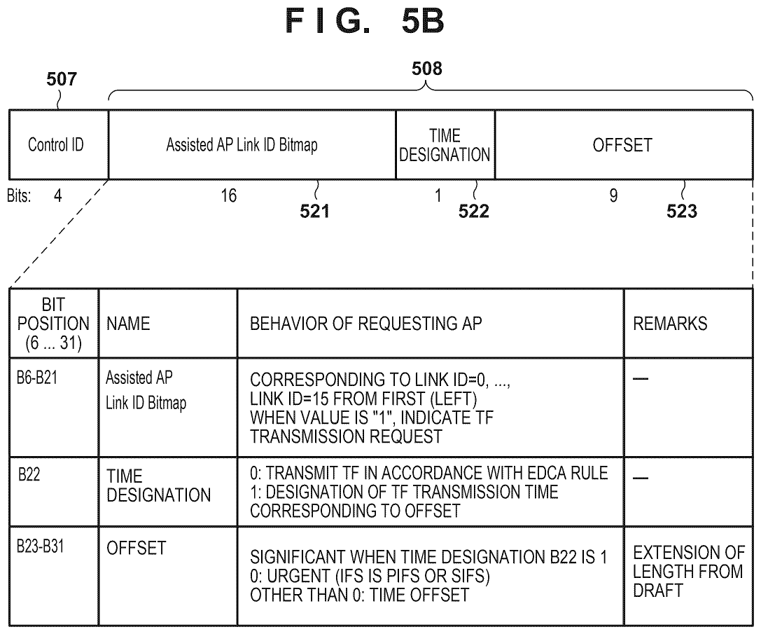

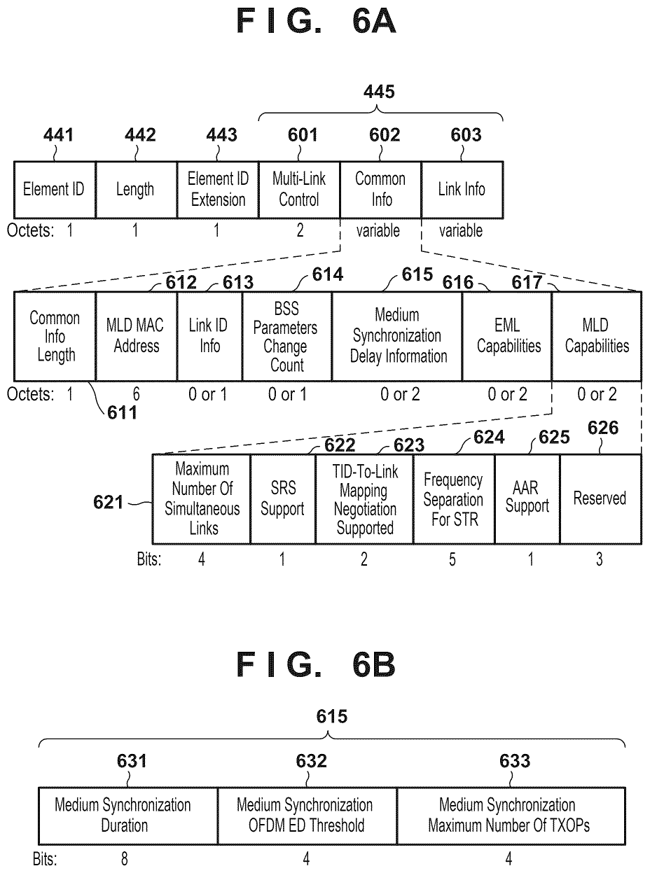

Subsequently, the structure of the Multi-Link element corresponding to a case where “107” is set in the Element ID Extension subfield shown in FIG. 4 will be described with reference to FIG. 6A. Note that the meanings of fields that are not specifically related to a description of this embodiment are apparent to those skilled in the art and thus only names are indicated. The subfields from the Element ID subfield 441 to the Element ID Extension subfield 443 are as described above with reference to FIG. 4.

A field 601 is a Multi-Link Control field. This field has a length of 1 byte (octet), and the first three bits indicate a Type field. In the case of “Basic Multi-Link element” to be described later, “0” is set in the Type field. A 1-bit Reserved field and a 12-bit Presence Bitmap follow the Type field. Five bits of the 12 bits indicate whether elements of fields 613 to 617 to be described later are included in the frame. A field 603 is a Link Info field.

A field 602 is a Common Info field. In the case of the Basic Multi-Link element, this field includes fields 611 to 617. The field 611 is a Common Info Length field. The field 612 is an MLD MAC Address field. MLD is an acronym for Multi Link Device. This address may be the value of a MAC address to be used for communication in each wireless link or a value different from that value. The field 613 is a Link ID Info field having a length of 1 byte, and the first four bits indicate a link ID. The field 614 is a BSS Parameters Change Count field. The field 615 is a Medium Synchronization Delay Information field. This field includes three subfields and details thereof will be described later. The field 616 is an EML Capabilities field. Note that EML is an acronym for Enhanced Multi-Link. The field 617 is an MLD Capabilities field.

The MLD Capabilities field 617 includes subfields 621 to 626. The subfield 621 is a Maximum Number Of Simultaneous Links subfield. The subfield 622 is an SRS (Single Response Scheduling) Support subfield. The subfield 623 is a TID-To-Link Mapping Negotiation Supported subfield. The subfield 624 is a Frequency Separation For STR subfield. The subfield 625 is an AAR Support subfield, and this one bit indicates the presence/absence of the capability of the AAR. The subfield 626 is a Reserved subfield.

Subsequently, the Medium Synchronization Delay Information field 615 will be described in detail with reference to FIG. 6B.

A Medium Synchronization Duration subfield 631 is a field having a length of 8 bits, and indicates the value of the MediumSyncDelay timer set by a synchronization recovery procedure not using the AAR in a unit of 32 μs. The maximum value is 32 μs×255=8.16 ms. A Medium Synchronization OFDM ED Threshold subfield 632 stores an ED (Energy Detection) value that is used in the synchronization recovery procedure and is added to −72 dBm. A Medium Synchronization Maximum Number Of TXOPs subfield 633 stores the maximum value of the number of times the synchronization recovery procedure is attempted.

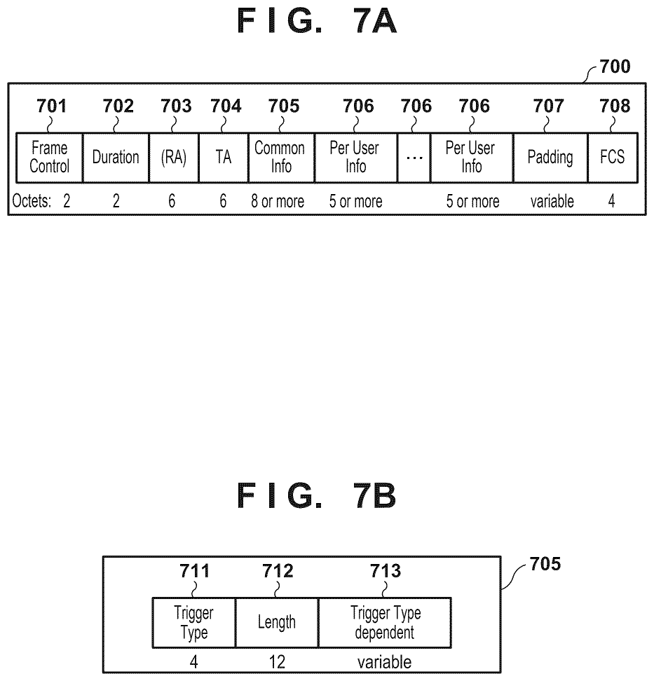

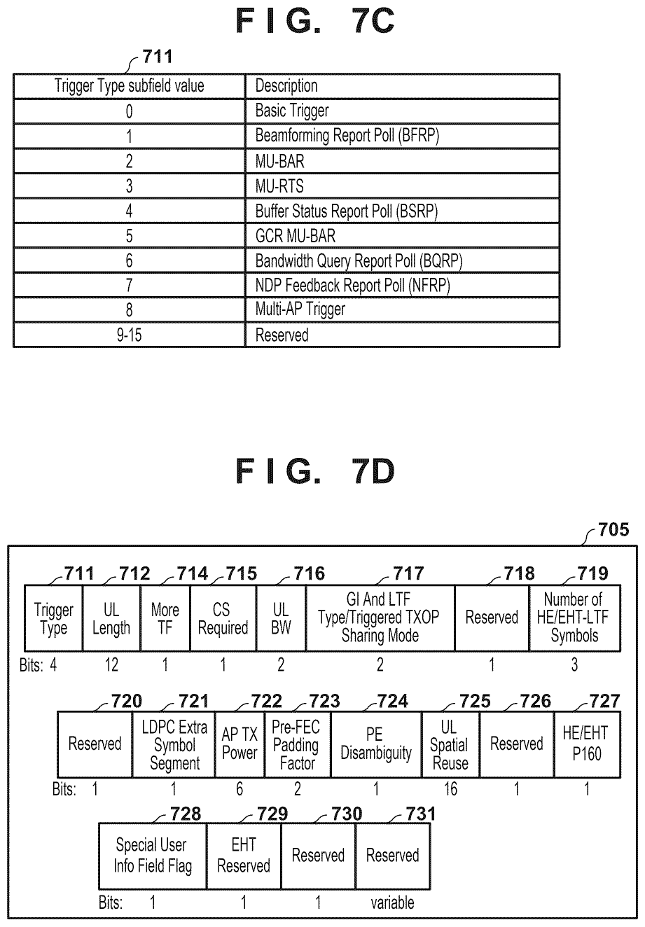

The structure of a trigger frame 700 transmitted from the AP will be described with reference to FIGS. 7A to 7D. The trigger frame is a frame introduced from the IEEE 802.11ax standard, and is used to indicate wireless channel information using an activation timing and a frame, which is necessary for a plurality of terminals (users) to transmit frames to the AP simultaneously.

Referring to FIG. 7A, a Frame Control field 701 is a field common to the IEEE 802.11 standard series and has a length of 2 octets (bytes). In this embodiment, a value indicating the trigger frame complying with the IEEE 802.11ax standard is set in the Frame Control field 701. A Duration field 702 is a field having a length of 2 octets (16 bits), and indicates a frame duration. An RA field 703 is a field having a length of 6 octets, and indicates a receiver address. A TA field 704 is a field having a length of 6 octets, and indicates a transmitter address.

A Common Info field 705 is a field having a length of 8 octets or more, and indicates information common to a plurality of terminals that are the destinations of the trigger frame. The Common Info field 705 will be described in detail later. A Per User Info field 706 is a field having a length of 5 octets or more, and indicates individual information for each of the destinations of the trigger frame. A Padding field 707 includes variable-length padding bits used to give a time to the terminal group that has received the trigger frame. The AP decides the time based on MinTrigProcTime of each STA. In general, the AP decides the length of the Padding field 707 so as to give the time of a length corresponding to the maximum value of MinTrigProcTime of the STA group as the destination of the trigger frame. An FCS field 708 is a frame check sequence for determining whether the frame has successfully been received.

Subsequently, the structure of the Common Info field 705 will be described with reference to FIG. 7B. A Trigger Type field 711 is a field having a length of 4 bits, and stores contents, as shown in FIG. 7C. For example, for Basic Trigger, “0” is set in the Trigger Type field 711. For Multi-AP Trigger, “8” is set in the Trigger Type field 711. A UL Length field 712 indicates the duration of response data to the trigger frame. The value in the UL Length field is reflected in the L-SIG field of the physical layer in a frame of the IEEE 802.11 standard. The L-SIG field includes information representing the duration of a frame having the field. A field 713 is a portion including different contents for each Trigger Type. Subfields 714 to 731 shown in FIG. 7D indicate the contents of the field 713 in the Common Info field 705 in a case where the Trigger Type is “Basic Trigger”.

The subfield 714 is a More Trigger Frame (TF) subfield 714 having a length of 1 bit. The subfield 715 is a Carrier Sense (CS) Required subfield 715 having a length of 1 bit. The AP sets “1” in this bit when requesting the STA to perform wireless media access control by a Network Allocation Vector (NAV) or a carrier sense (also called Energy Detect or Power Detect). That is, in a case where “0” is set in this bit, even if the wireless medium is busy or the NAV of the terminal is within a validity period, the STA can transmit a TB PPDU. Note that TB PPDU is an acronym for Trigger Based Physical layer Protocol Data Unit. If the AP and the STA perform wireless communication complying with the IEEE 802.11be standard, an EHT TB PPDU is transmitted, and if the AP and the STA perform wireless communication complying with the above-described UHR standard, a UHR TB PPDU is transmitted.

The subfield 716 is a UL BW (UpLink Bandwidth) subfield having a length of 2 bits. The subfield 717 is a GI And LTF Type (Guard Interval And

Long Training Field)/Triggered TXOP Sharing Mode subfield having a length of 2 bits. The subfield 718 is a Reserved subfield having a length of 1 bit. The subfield 719 is a Number of HE LTF Symbols subfield having a length of 3 bits. The subfield 720 is a Reserved subfield having a length of 1 bit. The subfield 721 is an LDPC (Low Density Parity Check) Extra Symbol Segment subfield having a length of 1 bit. The subfield 722 is an AP TX Power subfield having a length of 6 bits. The subfield 723 is a Pre-FEC Padding Factor subfield having a length of 2 bits. The subfield 724 is a PE Disambiguity subfield having a length of 1 bit. The subfield 725 is a UL Spatial Reuse subfield having a length of 16 bits. The subfield 726 is a Reserved subfield having a length of 1 bit. The subfield 727 is an HE/EHT P160 subfield having a length of 1 bit. The subfield 728 is a Special User Info Field Flag subfield having a length of 1 bit. The subfield 729 is an EHT Reserved subfield having a length of 7 bits. The subfield 730 is a Reserved subfield having a length of 1 bit. The subfield 731 is a Trigger Dependent Common Info subfield having a variable length.

### Procedure of Processing

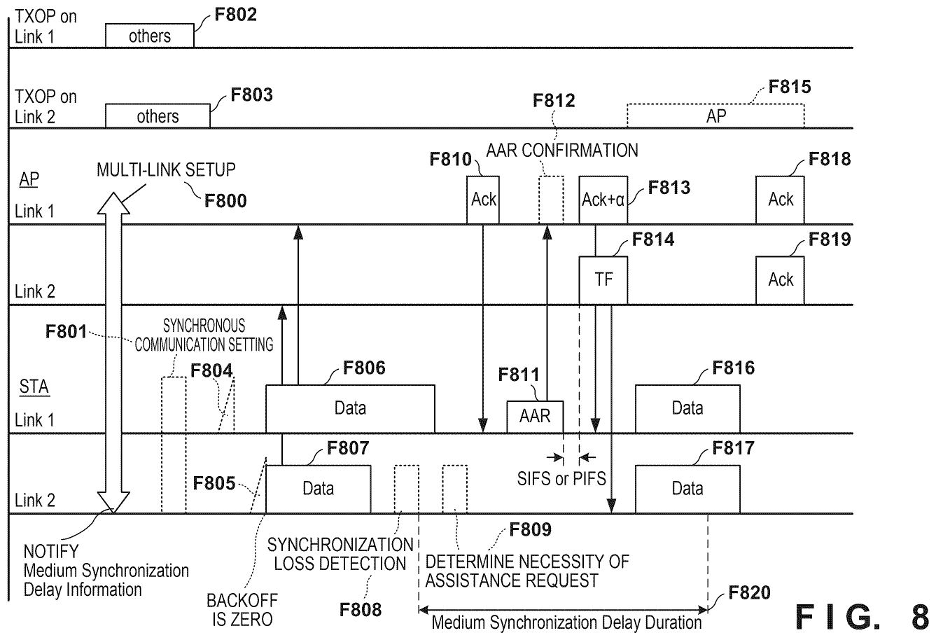

Subsequently, an example of the procedure of processing executed in the wireless communication system will be described. FIG. 8 is a sequence chart showing a first example of the procedure of communication in the wireless communication system according to this embodiment. FIG. 8 shows a procedure when the STA requests, upon detecting a synchronization loss, synchronization recovery assistance of “urgent” from the AP. This processing is executed, for example, between the AP 100 and the STA 101 or 102, but the AP 100 and the STA 101 or 102 will simply be referred to as “AP” and “STA” hereinafter if it is unnecessary to particularly discriminate them. Assume that the STA is the NSTR terminal and the AP is the STR terminal.

In this processing, first, the AP and the STA execute a Multi-Link setup procedure (F800). In this procedure, the AP notifies the STA of the above-described Medium Synchronization Delay Information field 615. Then, the STA executes setting of synchronous communication (F801). This setting includes decision of whether the communication is “urgent communication or real-time communication”. Based on the setting, the STA sends an urgent assistance request to the AP when a synchronization loss occurs. Note that the STA may notify the AP that the setting is executed. Note that as indicated by F802 and F803, it is indicated in the upper portion of FIG. 8 whether wireless medium transmission opportunities (TXOPs) corresponding to links 1 and 2 are obtained. Note that F802 and F803 indicate that another communication apparatus obtains the TXOPs of links 1 and 2.

Before transmitting data, the STA counts down the backoff counter of an Enhanced Distributed Channel Access (EDCA) operation in each of links 1 and 2 (F804 and 805). Then, when the backoff counters become 0, the STA simultaneously transmits data in links 1 and 2 (F806 and F807). Note that since the STA synchronizes the transmission start timings of links 1 and 2, the STA stands by for data transmission until the backoff counter becomes 0 in F805 without starting data transmission in F806 immediately after the backoff counter becomes 0 in F804. At this time, the STA maintains the value of the backoff counter in link 1 at “0” until it obtains an access right in link 2. Thus, when the STA obtains the access right in link 2, it can simultaneously transmit data using both links 1 and 2.

Assume that the STA ends data transmission in link 2 earlier than data transmission in link 1. In this case, the STA detects this state as a synchronization loss (F808). In this embodiment, “a state in which transmission end timings deviate from each other” in a plurality of links will be referred to as a “synchronization loss” state hereinafter. The transmission start timings in the plurality of links need not always be synchronized. Note that FIG. 8 shows an example in which the STA detects a synchronization loss a predetermined time after the end of data transmission in F807, but the STA may detect a synchronization loss at the end timing of data transmission in F807. Upon detecting a synchronization loss, the STA sets the Medium Synchronization Delay timer to the value of the Medium Synchronization Duration subfield 631 described with reference to FIGS. 6A and 6B, and activates it (F820). On the other hand, the STA decides whether to transmit an assistance request to the AP (F809). In this embodiment, assume that the STA decides to transmit an assistance request to the AP.

Upon receiving the data in link 1, the AP transmits an acknowledgement (ACK) to the STA (F810). In this embodiment, since the STA is the NSTR terminal, even if the AP transmits an ACK to the data transmitted in link 2, the STA cannot recognize the ACK during data transmission in link 1. It should be noted that in consideration of this case, FIG. 8 does not show an ACK in link 2.

After that, when deciding to transmit an assistance request, the STA transmits a PPDU including an AAR (AP Assistance Request) (F811). With respect to the PPDU transmitted here, in the MAC frame in the PPDU, “1” is set in the +HTC subfield of the Frame Control field 401, the HT Control field 409 is set for HE/EHT, and “10” is set in the Control ID subfield 507. In the Assisted AP Link ID Bitmap field 521 of the PPDU, “0100000000000000” indicating that the STA requests the AP to transmit a trigger frame in link 2 is set. In this bitmap, as described above, each bit corresponds to a link. For example, the first bit (leftmost bit) can correspond to link 1, and the second bit can correspond to link 2. To indicate that the TF is to be transmitted in link 2, the second bit corresponding to link 2 is set to “1”. In addition, to indicate that the TF transmission request is “urgent”, the STA sets “1” in the time designation field 522, and sets “0” in the offset field 523. Note that if the AP and the STA perform wireless communication complying with the IEEE 802.11be standard, an EHT PPDU is transmitted, and if the AP and the STA perform wireless communication complying with the above-described UHR standard, a UHR PPDU is transmitted.

The AP receives the PPDU from the STA, and analyzes the MAC frame (F812). If the AAR of the HT Control field is included, the AP confirms the contents, and decides the timing of transmitting the TF. Then, the AP transmits an ACK to the frame received in F811 (F813). Note that a Block ACK (BA) can generally be used. Therefore, throughout this embodiment, “ACK” may be replaced by “BA”. Furthermore, the AP transmits, in link 2, the TF requested by the AAR (F814). Note that if “urgent” is designated in the AAR transmitted in F811, the AP sets the IFS (Inter Frame Space) at the time of transmitting the TF to PIFS or SIFS. To align the end of the ACK in F813 with the end of the TF in F814, the AP adds a necessary Padding field to the ACK. Therefore, in FIG. 8, the ACK in F813 is expressed by “ACK+a”. Note that since the IFS is SIFS when transmitting the ACK in F813, if the IFS of the TF in F814 is set to PIFS, the AP can adjust the Padding field of the ACK to be longer than the Padding field added when the IFS is SIFS.

When the AP transmits the TF in this way, the TXOP is ensured (F815). Then, the STA transmits the data frames in links 1 and 2 (F816 and F817). The AP then transmits ACKs to the data frames (F818 and F819).

Note that if data transmission is incomplete in F807, the STA may retransmit part or all of the data using link 1 in F816. This can be performed in a case where the data can be transmitted in link 1 by TID-to-Link mapping. Note that TID-to-Link mapping can be used to decide a link allowed to be used to transmit data identified by a Traffic IDentifier. This decision processing may be performed at the time of the Multi-Link setup in F800 or at another timing. For example, this decision processing may be performed by a negotiation executed by the AP and the STA at an arbitrary timing. The STA may prepare data to be transmitted in F816 and F817 in a data transmission queue at a timing (for example, a timing of F809) before the AAR is transmitted in F811. That is, the STA may transmit the AAR to the AP in F811 when ready for synchronous communication.

Note that if “urgent” or the time is not designated in the AAR, as described above, the synchronization recovery procedure is executed at the timing when the Medium Synchronization Delay timer in F820 expires. In this case, if no effective frame is received in link 2, the STA refrains from transmitting a frame until the timer expires. Therefore, for example, the PPDU for the AAR in F811 is transmitted in link 1. Note that the effective frame in link 2 is a frame sent by the AP or another terminal. As is apparent from FIG. 8, with the procedure according to this embodiment, it is possible to recover synchronization early enough, as compared to a case where the synchronization recovery procedure is performed after the Medium Synchronization Delay timer expires. As a result, it is possible to efficiency of communication in the wireless communication system.

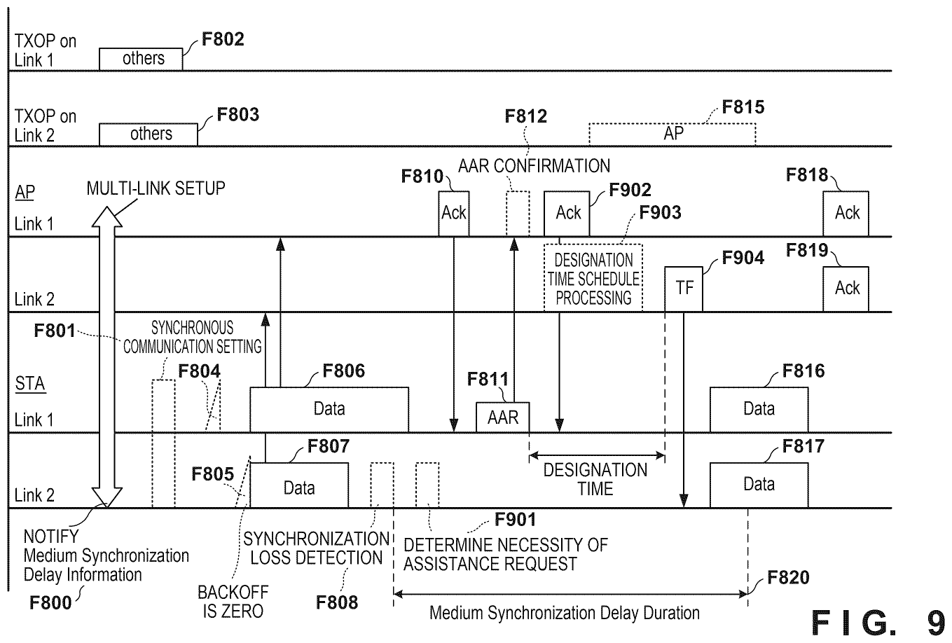

Subsequently, a second example of the procedure of communication in the wireless communication system according to this embodiment will be described with reference to FIG. 9. FIG. 9 shows a procedure when the STA requests, upon detecting a synchronization loss, synchronization recovery assistance of “non-urgent” from the AP. In FIG. 9, the same reference symbols as in FIG. 8 denote the same processes and a description thereof will be omitted.

In the example shown in FIG. 9, upon detecting a synchronization loss (F808), the STA decides to transmit the PPDU in which “1” is set in the time designation field 522 of the HT Control field of the AAR and a value “other than 0” is set in the offset field 523 (F901). Note that the remaining fields are the same as in the example shown in FIG. 8. The STA generates the PPDU and transmits it (F811), and the AP confirms the AAR included in the PPDU, transmits an ACK (F902), and sets the timing of transmitting the TF in link 2 (F903). Note that in this example, the AP does not immediately transmit the TF in link 2. Therefore, the ACK transmitted in F902 does not require a Padding field. This is because it is unnecessary to synchronize the end of the ACK with the end of the TF. On the other hand, the AP stands by until the timing designated by the offset field 523 included in the PPDU for the AAR, and transmits the TF (F904).

In this processing as well, the STA can recover synchronization earlier than the timing when Medium Synchronization Delay timer in F820 expires. This is achieved when the time designated in the offset field 523 is set to a value of a timing earlier than the value of the Medium Synchronization Duration subfield. Note that the value of the offset field 523 may be set so that the time designated in the offset field 523 is a timing after the value of the Medium Synchronization Duration subfield.

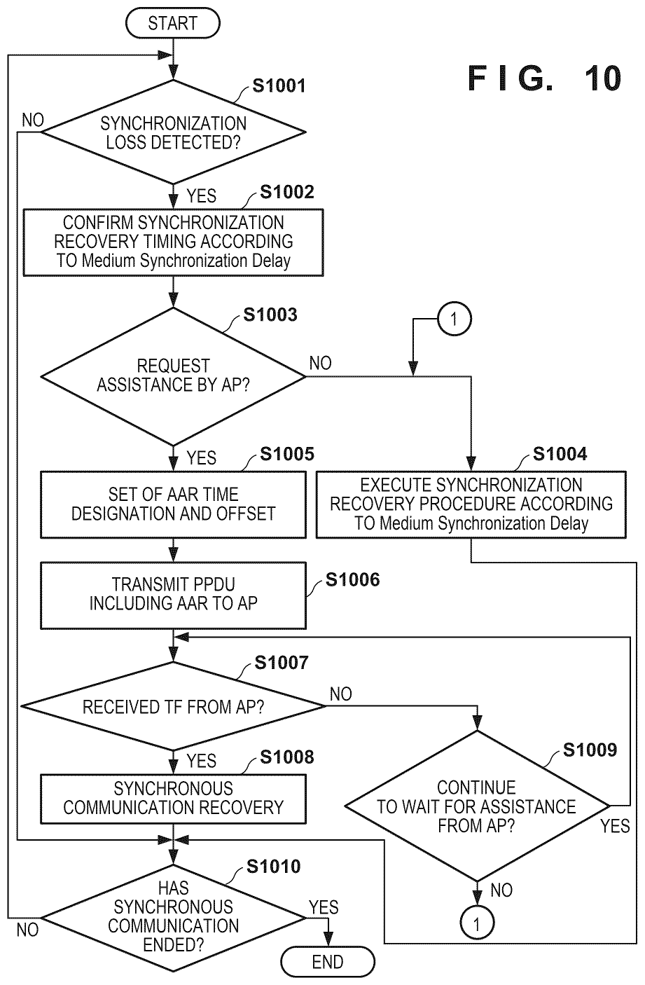

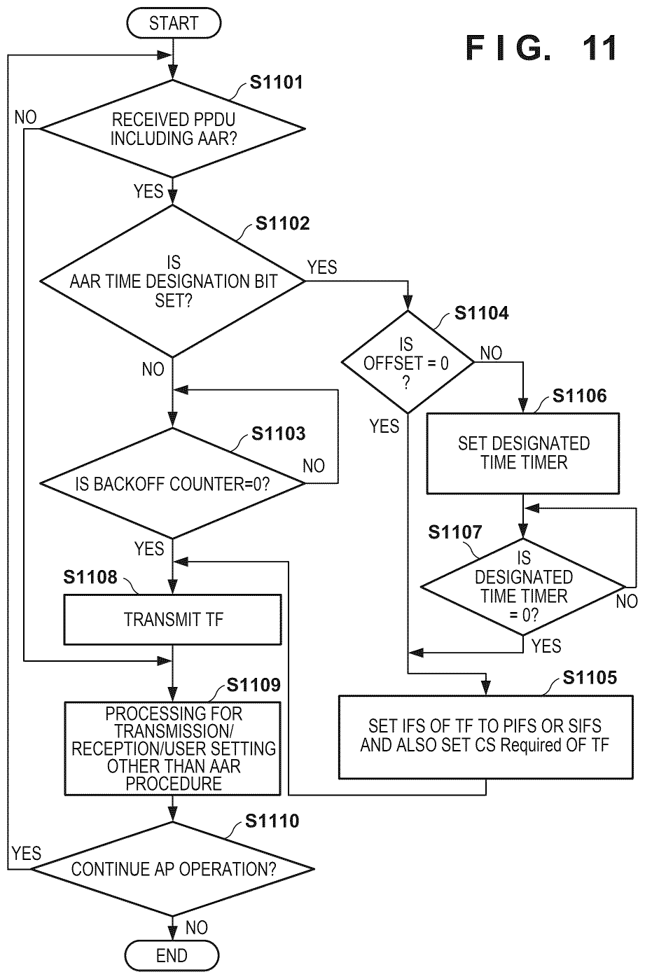

Subsequently, an example of the procedure of processing executed by the STA that starts synchronous communication in order to execute the above-described communication will be described with reference to FIG. 10. First, the STA continuously executes processing of detecting whether a synchronization loss occurs (step S1001). While no synchronization loss is detected (NO in step S1001), the STA continuously executes the processing of detecting a synchronization loss until synchronous communication ends (NO in step $1010). If a synchronization loss is detected (YES in step S1001), the STA confirms a synchronization recovery timing according to the Medium Synchronization Delay Information field 615 (step S1002). Note that a notification of the Medium Synchronization Delay Information field 615 can be sent in the Multi-Link setup procedure, as described above.

Then, the STA determines whether to request assistance for synchronization recovery from the AP (step S1003). The STA can perform this determination processing by, for example, comparing a synchronization recovery timing independent of the AAR with a synchronization recovery timing dependent on the AAR. For example, if the synchronization recovery timing independent of the AAR is earlier than the synchronization recovery timing dependent on the AAR, the STA can determine not to request assistance. If the synchronization recovery timing dependent on the AAR is earlier than the synchronization recovery timing independent of the AAR, the STA can determine to request assistance. Alternatively, if the synchronization recovery timing dependent on the AAR is earlier than the synchronization recovery timing independent of the AAR by a predetermined time or more, the STA may request assistance, and even if the synchronization recovery timing dependent on the AAR is earlier than the synchronization recovery timing independent of the AAR, if the time difference is smaller than the predetermined time, the STA need not request assistance.

If the STA determines not to request assistance from the AP (NO in step S1003), it executes the synchronization recovery procedure in accordance with the Medium Synchronization Delay Information field 615 (step S1004). In this procedure, the STA determines whether the time (length) of the frame to be transmitted is longer than MediumSyncThreshold (72 μs). Note that this determination processing is also executed in, for example, step S1003. If the time of the frame is longer than MediumSync Threshold, the STA starts the Medium Synchronization Delay timer. Then, the STA continuously executes Clear Channel Assessment (CCA), and starts transmission when the Medium Synchronization Delay timer expires. After that, if the STA ends synchronous communication (YES in step S1010), it ends the processing shown in FIG. 10. If the STA does not end synchronous communication (NO in step S1010), it returns the process to step S1001.

If the STA determines to request assistance from the AP (YES in step S1003), it sets the time designation field 522 and the offset field 523 of the AAR (step S1005). Then, the STA transmits the PPDU including the AAR to the AP (step S1006). The PPDU is a Management frame or a Data frame. To transmit the AAR by a short frame, QoS Null may be used. Then, the STA monitors whether a trigger frame is received from the AP (step S1007). If the STA confirms that the trigger frame is received (YES in step S1007), the STA recovers synchronous communication based on the trigger frame (step S1008). Recovery of synchronous communication indicates execution of transmission/reception processing in each of links 1 and 2. After that, if the STA ends synchronous communication (YES in step S1010), it ends the processing shown in FIG. 10. If the STA does not end synchronous communication (NO in step S1010), it returns the process to step S1001. On the other hand, if the STA does not confirm that the trigger frame is received (NO in step S1007), it determines whether to continuously wait for assistance from the AP (step S1009). If the STA determines not to continuously wait for assistance from the AP (NO in step S1009), it shifts the process to step S1004. If the STA determines to continuously wait for assistance from the AP, it continues confirmation of reception of the TF (step S1007).

Subsequently, an example of the procedure of processing executed by the AP in order to execute the above-described communication will be described with reference to FIG. 11. This processing corresponds to processing after execution of the Multi-Link setup between the AP and the STA. If the AP receives a PPDU, it determines whether the PPDU includes an AAR (step S1101). If the AP receives the PPDU including the AAR (YES in step S1101), it confirms whether the time designation field 522 in the AAR is set (step S1102). Note that in the PPDU including the AAR, only the bit corresponding to link 2 in the Assisted AP Link ID Bitmap field is set as a target link of the AAR. However, this is merely an example, and if a synchronization loss is detected in link 1, the bit corresponding to link 1 may be set as a target link of the AAR. Alternatively, if the PPDU including the Bitmap field set with an invalid bit is received, for example, if the bit corresponding to a link that is not established between the AP and the STA is set as a target link of the AAR, the AP can shift the process to step S1009. That is, if the AP receives the PPDU including the AAR with the invalid Bitmap field, it can perform the same processing as in a case where the PPDU including no AAR is received.

If the time designation field 522 in the AAR is not set (NO in step S1102), the AP confirms whether the backoff counter when transmitting a trigger frame by the EDCA access method is 0 (step S1103). Note that “the time designation field 522 is not set” indicates that the time designation field 522 is set to a predetermined value (for example, “0”) representing that the time is not designated. This case corresponds to a case where the STA requests assistance for synchronization recovery from the AP but the transmission timing of a trigger frame for this is not designated. Therefore, the AP transmits the trigger frame by the EDCA access method. That is, when the backoff counter becomes 0 (YES in step S1103), the AP transmits the TF (step S1108). On the other hand, if the time designation field 522 in the AAR is set (YES in step S1102), the AP confirms whether the offset field 523 in the AAR is 0 (step S1104). If the offset field 523 in the AAR is 0 (YES in step S1104), the AP sets the IFS of the trigger frame to PIFS or SIFS (step S1105) since the assistance request is “urgent”, and transmits the trigger frame (step S1108). On the other hand, if the offset field 523 in the AAR is not 0 (NO in step S1104), the AP sets the designated time timer, and starts the timer (step S1106). This timer expires at the time corresponding to the offset designated by the STA. If the designated time timer expires (YES in step S1107), the AP shifts the process to step S1105. Note that when the designated time timer expires, the AP may advance the process to step S1103 or S1108 instead of step S1105. That is, the AP may transmit the TF by the EDCA access method in step S1103 after the designated time timer expires, or may transmit the TF strictly at the timing designated by the offset of the STA in step S1108 after the designated time timer expires.

When the PPDU including no AAR is received, or after transmitting the trigger frame in step S1108, the AP performs transmission, reception, and user setting processing other than the AAR procedure (step S1109). Then, the AP determines whether to continue the AP operation (step S1110). If the AP continues the AP operation (YES in step S1110), it returns the process to step S1101. If the AP does not continue the AP operation (NO in step S1110), it ends the processing.

As described above, if a synchronization loss occurs in the STA as the NSTR terminal that executes Multi-Link communication complying with the IEEE 802.11 standard series, it is possible to recover the synchronization earlier than in a case where synchronization recovery is executed in accordance with a normal timer. Thus, communication in which a plurality of wireless links are synchronized can be executed, thereby improving efficiency of communication.

Note that in the above-described embodiments, in the context of communication between the AP and the STA, processing in a case where the STA requests the AP to transmit a trigger frame for synchronization recovery has been explained. However, this is merely an example. For example, the above-described procedure may be used for synchronous communication between arbitrary two communication apparatuses. That is, in a case where a synchronization loss occurs in a state in which the first communication apparatus transmits signals to the second communication apparatus so that the end timings of the signals in the first wireless link and the second wireless link are synchronized (coincide), the above-described procedure can be used. In this case, the first communication apparatus requests the second communication apparatus to transmit a predetermined signal for synchronization recovery, and includes, in the request, information for specifying the transmission timing of the predetermined signal. Thus, the second communication apparatus can transmit the predetermined signal at the timing specified based on the information, and the first communication apparatus can recover synchronization between the plurality of wireless links based on the predetermined signal. In an example, the first communication apparatus and the second communication apparatus may be STAs complying with the IEEE 802.11 standard series. That is, in the above-described embodiment, the example in a case where the AAR is used has been explained. However, the partner apparatus as the transmission destination of the assistance request associated with synchronization recovery need not be an AP.

According to the present disclosure, it is possible to improve efficiency of Multi-Link communication.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A communication apparatus for performing wireless communication complying with an IEEE 802.11 standard, comprising:
a communication unit configured to perform communication by establishing a first wireless link and a second wireless link with another communication apparatus; and
a control unit configured to control, in a case where transmission of a second frame in the second wireless link ends while transmitting a first frame in the first wireless link in a state in which the communication unit transmits frames so that a first timing at which a frame transmitted in the first wireless link ends is synchronized with a second timing at which a frame transmitted in the second wireless link ends, the communication unit to transmit, to the other communication apparatus in the first wireless link, a predetermined frame that requests assistance for recovery of the synchronization from the other communication apparatus and includes information capable of designating a timing of recovering the synchronization.

2. The communication apparatus according to claim 1, wherein the information capable of designating the timing includes first information indicating whether to designate a timing, and second information indicating the timing in a case where the first information indicates that the timing is designated.

3. The communication apparatus according to claim 2, wherein in a case where the assistance is requested of the other communication apparatus without designating the timing, the first information is set to a value indicating that the timing is not designated.

4. The communication apparatus according to claim 1, wherein the other communication apparatus is an Access Point (AP), and the predetermined frame is a Physical layer Protocol Data Unit (PPDU) including an AP Assistance Request (AAR).

5. The communication apparatus according to claim 4, wherein the AAR includes a bit map formed from bits respectively corresponding to a plurality of wireless links, and
in a case where transmission of the second frame in the second wireless link ends while transmitting the first frame in the first wireless link, a bit of the second wireless link is set to a predetermined value indicating an assistance target.

6. The communication apparatus according to claim 4, wherein the information capable of designating the timing includes a value that designates a timing earlier than a timing specified by Medium Synchronization Duration of an IEEE 802.11be standard.

7. The communication apparatus according to claim 1, wherein if the assistance is not requested of the other communication apparatus, the control unit controls the communication unit not to transmit the predetermined frame.

8. A communication apparatus for performing wireless communication complying with an IEEE 802.11 standard, comprising:
a communication unit configured to perform communication by establishing a first wireless link and a second wireless link with another communication apparatus; and
a control unit configured to control, in a case where a first predetermined frame that requests assistance for recovery from a synchronization loss between the first wireless link and the second wireless link in the other communication apparatus and includes information capable of designating a timing of recovering synchronization is received in the first wireless link from the other communication apparatus, the communication unit to transmit a second predetermined frame in the second wireless link at a timing based on the information capable of designating the timing.

9. The communication apparatus according to claim 8, wherein the information capable of designating the timing includes first information indicating whether to designate a timing, and second information indicating the timing in a case where the first information indicates that the timing is designated.

10. The communication apparatus according to claim 9, wherein in a case where the first predetermined frame in which the first information is set to a value indicating that the timing is not designated is received, the second predetermined frame is transmitted using Enhanced Distributed Channel Access (EDCA).

11. The communication apparatus according to claim 8, wherein
the communication apparatus is an Access Point (AP), and
the first predetermined frame is a Physical layer Protocol Data Unit (PPDU) including an AP Assistance Request (AAR).

12. The communication apparatus according to claim 11, wherein
the AAR includes a bit map formed from bits respectively corresponding to a plurality of wireless links, and
in a case where the second predetermined frame is to be transmitted in the second wireless link, a bit of the second wireless link is set to a predetermined value indicating an assistance target.

13. The communication apparatus according to claim 11, wherein the information capable of designating the timing includes a value that designates a timing earlier than a timing specified by Medium Synchronization Duration of an IEEE 802.11be standard.

14. The communication apparatus according to claim 8, wherein the second predetermined frame is a trigger frame.

15. A control method executed by a communication apparatus for performing wireless communication complying with an IEEE 802.11 standard, comprising:
performing communication by establishing a first wireless link and a second wireless link with another communication apparatus; and
transmitting, in a case where transmission of a second frame in the second wireless link ends while transmitting a first frame in the first wireless link in a state in which frames are transmitted so that a first timing at which a frame transmitted in the first wireless link ends is synchronized with a second timing at which a frame transmitted in the second wireless link ends, a predetermined frame that requests assistance for recovery of the synchronization from the other communication apparatus and includes information capable of designating a timing of recovering the synchronization to the other communication apparatus in the first wireless link.

16. A control method executed by a communication apparatus for performing wireless communication complying with an IEEE 802.11 standard, comprising:
performing communication by establishing a first wireless link and a second wireless link with another communication apparatus; and
transmitting, in a case where a first predetermined frame that requests assistance for recovery from a synchronization loss between the first wireless link and the second wireless link in the other communication apparatus and includes information capable of designating a timing of recovering synchronization is received in the first wireless link from the other communication apparatus, a second predetermined frame in the second wireless link at a timing based on the information capable of designating the timing.

17. A non-transitory computer-readable storage medium that stores a computer program for causing a computer, included in a communication apparatus for performing wireless communication complying with an IEEE 802.11 standard, to perform a control method comprising:
performing communication by establishing a first wireless link and a second wireless link with another communication apparatus; and
transmitting, in a case where transmission of a second frame in the second wireless link ends while transmitting a first frame in the first wireless link in a state in which frames are transmitted so that a first timing at which a frame transmitted in the first wireless link ends is synchronized with a second timing at which a frame transmitted in the second wireless link ends, a predetermined frame that requests assistance for recovery of the synchronization from the other communication apparatus and includes information capable of designating a timing of recovering the synchronization to the other communication apparatus in the first wireless link.

18. A non-transitory computer-readable storage medium that stores a computer program for causing a computer, included in a communication apparatus for performing wireless communication complying with an IEEE 802.11 standard, to perform a control method comprising:
performing communication by establishing a first wireless link and a second wireless link with another communication apparatus; and
transmitting, in a case where a first predetermined frame that requests assistance for recovery from a synchronization loss between the first wireless link and the second wireless link in the other communication apparatus and includes information capable of designating a timing of recovering synchronization is received in the first wireless link from the other communication apparatus, a second predetermined frame in the second wireless link at a timing based on the information capable of designating the timing.
